(19) United States
(12) Patent Application Publication
(10) Pub. No.: US 2026/0217195 A1
(43) Pub. Date: Jul. 30, 2026

(54) ELECTROMOTIVE FOOTBOARD FOR A MOTOR VEHICLE

(71) Applicant: Brose Fahrzeugteile SE & Co. Kommanditgesellschaft, Bamberg, Bamberg (DE)

(72) Inventors: Florian WöLKER, Hausen (DE); Christoph HABERBERGER, Gößweinstein (DE); Adam LACZO, Bischberg (DE); Felix PANUSCH, Bamberg (DE)

(21) Appl. No.: 19/292,442

(22) Filed: Aug. 6, 2025

(30) Foreign Application Priority Data
Aug. 6, 2024 (DE) 102024207437.3

(51) Int. Cl. B60R 3/02; B60R 16/03; F16H 37/12

(52) U.S. Cl. CPC B60R 3/02; B60R 16/03; F16H 37/122

(57) ABSTRACT

An electromotive footboard for a motor vehicle, comprising a board which is driven via of a drive which has an electric motor and a gear unit driven thereby and having an output shaft. The gear unit comprises a first gear stage and a second gear stage, wherein the first gear stage has a worm gear set, and wherein a drive shaft and an output shaft of the second gear stage are parallel to each other. Furthermore, present the invention relates to a motor vehicle.

The invention relates to an electromotive footboard for a motor vehicle and a motor vehicle with an electromotive footboard. The electromotive footboard has a board that is driven by a drive that includes an electric motor.

Relatively high-built motor vehicles, such as off-road vehicles or pick-up trucks, usually have footboards, also known as steps, to make it easier to get into the vehicle. These are mounted below a door and extend from the lower end of the body towards the floor. This means that a person can use the footboard as an intermediate step when getting in and out and can therefore overcome even relatively large height differences. For example, the footboard is rigidly mounted to the body of the vehicle. The disadvantage of this is that the ground clearance of the vehicle is reduced throughout and the lateral dimensions are increased. If the motor vehicle is driven on rough terrain, it is possible that the footboard comes into contact with the ground and, for example, becomes damaged or torn off. In addition, in the event of an accident, the risk of injury to other persons is increased and the aerodynamics of the vehicle are likewise impaired.

To remedy this, it is known to design the footboard with an electric motor. A drive with an electric motor is provided, by means of which the board, which serves as a step, is driven. Using a kinematic system, it is possible to swivel the board and, in particular, to lift it and store it underneath the body when it is not in use. As a result, the disadvantages of the rigid connection are eliminated.

However, it is necessary to ensure that the board remains securely in the extended position, even when a person steps on it. In other words, it is necessary that there is no movement even when a comparatively large weight load is applied. For this purpose, there are, for example, additional brakes or locking elements that are only engaged when the board is in the extended position. This is comparatively robust, however, it makes construction more difficult and requires additional components.

An alternative is to design the drive in such a way that the electric motor does not reverse even when the board is loaded. For this purpose, the drive is usually designed to be self-locking. For example, a single worm gear set can be used for this, which is mechanically arranged between the electric motor and the board. Since the acting forces are comparatively large, it is necessary to design the worm gear set in a relatively solid manner, which increases weight and material costs. Therefore, an alternative provides to use two worm gear sets connected in series to achieve self-locking. Consequently, the requirements for each worm gear set are reduced, wherefore the manufacturing costs are reduced. However, the required installation space is comparatively large.

In addition, the maximum achievable reduction ratio using the worm gear set s limited, at least due to the available installation space. In order to provide sufficient power for self-locking and adjusting the board, an electric motor with a comparatively high torque is required. This in turn requires a comparatively cost-intensive and large electric motor.

The invention is based on the object of specifying a particularly suitable electromotive footboard for a motor vehicle and a particularly suitable motor vehicle, wherein the required installation space and/or manufacturing costs are expediently reduced.

In relation to the electromotive footboard, this object is achieved by the features of claim 1 and in relation to the motor vehicle by the features of claim 11 according to the invention. Advantageous further developments and refinements are the subject matter of the respective subclaims.

The electromotive footboard is suitable, particularly intended and configured, to be mounted on a motor vehicle or at least to form a component of the motor vehicle in the mounted state. The motor vehicle is suitably land-based and preferably multi-lane. In this case, it is suitably possible to position the motor vehicle essentially freely, in particular on a roadway. For this purpose, the motor vehicle is expediently equipped with appropriate wheels. In summary, it is preferably possible to position the motor vehicle essentially independently of other conditions on land. In other words, the motor vehicle is suitably not rail-guided. Preferably, the motor vehicle is a passenger car or a commercial vehicle, such as a truck or bus.

The electromotive footboard has a board. The board is used for one person to climb on and/or support themselves and is suitable, particularly intended and equipped for this purpose. In other words, the board is particularly a type of step, or it acts in the manner of a step. The board itself is suitably adjustable, in particular by means of a mechanism/kinematics of the electromotive footboard. By means of the mechanical/kinematic system, the board is expediently arranged on the outside of a body of the motor vehicle in the assembled state, and by means of the mechanical or kinematic system it is possible to pivot or at least adjust the board. In particular, it is possible to change a distance of the board to the ground and/or to at least partially adjust a protrusion of the board over other components of the body.

Preferably, the board is associated with a door of the motor vehicle and is arranged in particular vertically below the door, i.e. below an opening in the body associated with the door. For example, the motor vehicle is designed in the manner of a train, a tram or a bus. It is particularly preferred, however, that the motor vehicle is a passenger car and is designed, for example, in the manner of a small van, off-road vehicle or pick-up truck.

The board is powered by means of a drive of the electromotive footboard, which includes an electric motor. The electric motor is preferably a brushed commutator motor or, alternatively, of brushless design. For example, the electric motor is a brushless direct current (BLDC) motor. The electric motor preferably has a stator and a rotor which is mounted rotatably in relation to the stator about a rotation/rotational axis, which thus corresponds to the rotational axis of the electric motor. The electric motor is designed in such a way that when the electric motor is energized, a rotating magnetic field is created, which sets the rotor into a rotational movement in relation to the stator. Preferably, the electric motor comprises a housing by means of which the stator is at least partially surrounded and thus protected.

The drive also includes a gear unit that is driven by the electric motor. The board is driven in turn by means of the gear unit, either directly or indirectly via another component. At least the gear unit, however, is mechanically located between the board and the electric motor. The gear unit has a first and a second gear stage. The first gear stage is expediently located between the electric motor and the second gear stage. For example, the gear unit comprises further gear stages or is expediently formed by means of the two gear stages. Thus, the first gear stage is driven by the electric motor and the second gear stage is driven by the first gear stage.

The first gear stage has a worm gear set. For example, the first gear stage comprises additional components or is expediently formed with them. The worm gear set comprises a worm and a worm gear, which is also called a helical gear. The axes of rotation of the worm and the worm gear are preferably arranged vertically, but offset from each other so that they do not intersect. Preferably, the worm is placed on a shaft of the electric motor and secured there. Consequently, the drive shaft of the first gear stage is formed by means of the shaft of the electric motor. This increases compactness and reduces the number of different components.

The second gear stage has a drive shaft and an output shaft. In particular, the drive shaft is coupled to the worm gear set and formed, for example, by means of the output shaft of the worm gear set, which further reduces the size. If only the two gear stages are present, the output shaft of the drive is formed in particular by means of the output shaft of the second gear stage. The second gear stage is designed such that the drive shaft of the second gear stage and the output shaft of the second gear stage are parallel to each other. For example, they lie on a common straight line or are expediently offset from each other.

Due to the two gear stages, it is possible to achieve a comparatively high reduction ratio, so that a comparatively high-speed electric motor can be used, wherein the provided speed is reduced by means of the gear so that, by means of the drive, a comparatively high torque is provided. Hereby, it is not necessary to provide high torque using the electric motor itself. Consequently, it can be designed to be comparatively compact, so that the required installation space is reduced. This likewise reduces weight and manufacturing costs.

Due to the worm gear set, a 90° deflection occurs at least once, wherein, via the second gear stage, no further deflection occurs. This makes it possible to design the drive in a comparatively compact manner, which the space required for the electromotive footboard is further reduced.

Further, due to the two parallel shafts of the second gear stage, it is possible to select a comparatively high reduction ratio and/or to design it in a self-locking manner, or at least to select a low efficiency. This reduces the load on the worm gear set and ensures comparatively safe self-locking. For example, only one of the two gear stages is designed to be self-locking, or both gear stages are designed to be self-locking. It is particularly preferred, however, that these are not self-locking individually, wherein the combination, i.e. the series connection of the two gear stages, is self-locking. This reduces the load and demands on the individual components, so that the required robustness is reduced. This means that they can be manufactured in a comparatively delicate manner wherein no damage is caused nevertheless. Therefore, manufacturing costs are further reduced.

For example, the gear unit has an additional gear stage by means of which a redirection takes place. For example, the rotational axis of the electric motor is arranged parallel to the output shaft of the drive or has another angle. It is particularly preferred, however, that, between the rotational axis of the electric motor and the output shaft of the gear unit, by means of which also the output shaft of the drive is preferably formed, a 90° angle is formed so that they are perpendicular to each other. For example, the rotational axis and the output shaft of the gear unit intersect, or they are spaced apart from each other, i.e. they are skew. For example, several additional gear stages are present, by means of which no further deflection or deflections can occur that neutralize each other. It is particularly preferred, however, that the gear unit only has the two gear stages.

Due to the 90° angle, the longitudinal extension of the drive is reduced and it can be arranged in a comparatively compact manner. Preferably, the rotational axis of the electric motor is arranged substantially perpendicular to the board. This makes it possible to insert the electric motor into a holder in the body or to insert it through a recess in the body so that it is protected by means of the body. This also reduces the installation space required outside the body, wherefore the electromotive footboard does not result in a reduction in ground clearance and/or a widening of the vehicle.

For example, the second gear stage comprises a spur gear, which has, for example, straight or preferably helical toothing. In this way, in particular, a comparatively large force transmission is enabled, wherein, for example, at least partially, self-locking is provided. Alternatively, the second gear stage comprises, for example, a planetary gear.

It is particularly preferred, however, that the second gear stage particularly preferably comprises an eccentric gear and is expediently formed with this. Due to the design as an eccentric gear, it is possible to select a comparatively high reduction ratio, so that a comparatively high-speed electric motor can also be used, wherein, by means of the drive, by a comparatively low speed and high torque are provided. Also, due to the comparatively high reduction ratio, a load on the board, especially when a person steps on it, is transferred into a high speed acting on the worm gear set, which can be absorbed comparatively well to achieve the self-locking.

In particular, the eccentric gear has an eccentric cam on which a first gearwheel is rotatably mounted, which is also referred to as a wobble wheel. For example, as a bearing, a plain bearing or preferably a rolling bearing, such as a ball bearing, is used. The eccentric cam is fastened to the drive shaft of the second gear stage and is offset radially outwards with respect to the rotational axis of the drive shaft of the second gear stage. Thus, the eccentric cam and therefore also the rotational axis of the first gearwheel is rotated around the rotational axis of the drive shaft of the second gear stage.

The first gearwheel is preferably externally toothed and engages with an internal toothing of a second gearwheel of the eccentric gear, which is suitably fastened to the output shaft of the second gear stage. Thus, when the drive shaft is driven, the eccentric cam is moved and the first gearwheel rolls on the inside of the second gearwheel, which is thus set into a rotary motion.

In particular, the first gearwheel, suitably the bearing associated with the first gearwheel, is guided by means of a cross slide which acts in the manner of an Oldham coupling or similar. The cross slide has a first motion link to which the bearing is connected, and which is mounted in a longitudinally movable manner on a second link. This in turn is mounted in a vertically and longitudinally movable manner, particularly on a housing of the gear unit. The two motion links are each expediently mounted in such a way that they are slideable. In addition, the bearings of the motion links are perpendicular to the rotational axis of the first gearwheel. The cross slide is comparatively compact, wherein the offset of the rotation axes of the two gears of the eccentric gear is compensated.

For example, the eccentric cam is spaced apart from the worm gear set and, for example, is fastened to the end of the output shaft of the first gear stage. It is particularly preferred, however, that the eccentric cam of the eccentric gear is fastened directly to the worm gear. As a result, the axis around which the eccentric cam is moved corresponds to the rotational axis of the worm gear. In particular, the eccentric cam and the worm gear are formed by means of a common component, and these are expediently pre-molded, for example by means of plastic injection molding. In this way, the number of required components and the number of work steps for manufacturing the drive are further reduced. In addition, the size has been further reduced.

Preferably, the electromotive footboard comprises an electronic system by means of which the electric motor is energized. For example, it is spaced apart from the drive. It is particularly preferred, however, that the electronic system is a component of the drive and arranged on the electric motor. In particular, they are in mechanical contact with each other. In other words, it is an integrated electronic system. This further increases compactness and makes installation easier.

In particular, the electronic system is located between the electric motor and the gear unit. The electronic system expediently has a circuit board. For example, the circuit board is arranged on the same plane as the worm gear. Thus, a comparatively flat drive is provided. Alternatively, the circuit board is rotated by 90° in relation to the worm gear, so that it runs parallel to the output shaft of the first gear stage and/or the output shaft of the second gear stage/drive. Thus, it is protected from mechanical damage, wherein an available space can be used in a comparatively efficient manner. Preferably, the electric motor is designed as a brushed commutator motor. The circuit board is suitably routed to the brushes or at least one brush holder of the electric motor and is suitably plugged in there. Thus, compactness is further increased.

For example, the electric motor and the gear unit are manufactured separately and flanged together for assembly. It is particularly preferred, however, that the drive has a common housing which is made in particular from a plastic, suitably by means of plastic injection molding. By means of the housing, the individual components of the drive were arranged in relation to each other, i.e. the individual gear stages and the electric motor. Thus, assembly is made easier and compactness is further increased. In addition, it is not necessary to equip each individual component with a separate housing, which further reduces weight/size/manufacturing costs.

Preferably, the housing has several holders. The individual components of the drive, such as the electric motor, the gear unit and any electronic system, are inserted into the different holders. Preferably, all or at least some of the holders are closed by means of a respective cover. These are, for example, separate from each other or preferably molded for a perfect fit so that they can be assembled in a single step. For example, a screw connection is used for this, or the covers are glued or welded, which increases tightness. Due to the common housing, the individual components of the drive are stabilized and adjusted to each other, which is why this does not have to be done in the installed state, which makes assembly easier. In addition, robustness is increased due to the common housing. The penetration of foreign particles is likewise prevented.

For example, a different housing is used for different applications/vehicle types, respectively, i.e. especially when different reduction ratios are required. It is particularly preferred, however, that the housing has an adjustable mounting of the worm gear on the housing. Thus, it is possible to use different worm/helical gears that have a different diameter and therefore a different number of teeth. Thus, it is possible to adapt the reduction ratio to the respective application, wherein, with the exception of the worm gear, identical parts can be used, at least for the housing, the electric motor and the rest of the first gear stage. In addition, for example, the same second gear stage can always be used, or it can be adapted to the worm gear used. Because the parts are identical, stockkeeping is simplified. It is likewise not necessary to keep different molds for the housing if the housing is designed as a plastic injection-molded part.

For adjustable bearings, for example, different bearing locations are provided in the holder if present, which are designed in particular in the manner of blind holes or similar, into which, for example, the output shaft of the first gear stage is inserted, so that a plain bearing is formed there. Alternatively, a rolling bearing or similar is used there, for example. In a further alternative, for example, the mold in which the housing is cast has a movable slide by means of which the position of the bearing location is predetermined. Thus, subsequent assembly is made easier, while still allowing adjustable mounting of the worm gear on the housing.

For example, the individual components of the drive are each mounted directly on the further components of the motor vehicle, or alternatively, the drive has the common housing, which is in particular fastened directly to the body. It is particularly preferred, however, that the electromotive footboard comprises an enclosure by means of which the drive is enclosed. The enclosure is designed to be tight and ideally meets a protection classification of at least IP 54 or IP 68. As a result, the entry of foreign particles and/or moisture is avoided. In summary, the drive is encapsulated by means of the tight enclosure. Preferably, the drive has the common housing, which makes installation within the enclosure easy. Due to the enclosure, it is likewise possible to arrange the drive in an unprotected area of the motor vehicle that is exposed, for example, to corrosive environments such as salt water or similar, wherein a damage to the drive does not occur.

The enclosure, for example, is designed in one piece and is built around the drive, in particular in a pre-molded manner. Preferably, however, the enclosure comprises a shell which is closed by means of a cover. Thus, it is possible to arrange the drive in the enclosure. For example, the lid is welded to the shell. Preferably, however, the cover is detachably fastened to the shell, for example by means of screws. Thus, on the one hand, a comparatively high contact pressure can be achieved, wherein, on the other hand, opening is still possible, particularly for maintenance and/or repair of the drive. In particular, a seal is arranged between the cover and the shell. Preferably, the output shaft of the gear unit projects through the enclosure, or a component driven by the output shaft is incorporated into the enclosure, which improves the tightness.

For example, the output shaft of the drive directly drives any mechanical/kinematic systems of the electromotive footboard. Here, a gearwheel of the mechanical/kinematic system, for example, is mounted on the output shaft of the gear unit, which in particular forms the output shaft of the drive. It is particularly preferred, however, that a coupling is arranged at the end of the output shaft of the gear unit/drive. With this, a corresponding coupling of the mechanical/kinematic system is engaged, in particular in a force-fitting and/or form-fitting manner, so that it is driven there. As a result, it is possible to manufacture and assemble the kinematic/mechanical system independently of the drive, wherefore different suppliers can be used for this purpose. Thus, storage and assembly on the vehicle is made easier. Due to the coupling, particularly by means of interlocking, the connection between the mechanical system and the drive is made possible, wherefore no special tools are required.

For example, the coupling is designed to be rigid. It is particularly preferred, however, that the coupling is designed as a mechanical overload coupling. In other words, the overload coupling is thus integrated into the drive. The overload coupling is, for example, a shear bolt or a friction coupling. It is particularly preferable, however, that the overload coupling is designed as a tolerance ring coupling. Thus, the manufacturing costs are reduced and reusability is ensured. The force at which the overload coupling is triggered can be adjusted in a comparatively precise manner, and manufacturing costs are comparatively low. The overload coupling is expediently triggered when excessive force is applied to the board, which would otherwise lead to the destruction of the gear unit, particularly due to the existing self-locking mechanism. Consequently, it is protected from damage. Expediently, the release force of the overload coupling is selected in such a way that it is only exceeded if the electromotive footboard is used improperly. Thus, injury to a person is ruled out.

The motor vehicle is suitably land-based and, for example, a passenger car. Alternatively, the motor vehicle is a commercial vehicle, for example a truck or a bus. The motor vehicle comprises in particular a body with an opening. Here, the opening can be covered by means of a door which is expediently mounted to the body in an adjustable manner, for example by means of a hinge and/or a guide rail. The door is associated with an electromotive footboard with a board. Further, the electromotive footboard comprises a drive by means of which the board is driven. The drive has an electric motor and a gear unit driven by the motor with an output shaft, which comprises a first gear stage and a second gear stage. The first gear stage has a worm gear set. A drive shaft and an output shaft of the second gear stage are parallel to each other.

In particular, the board is arranged vertically below the door or at least the opening that can be covered by the door. A mechanical/kinematic system of the electromotive footboard is suitably fastened to the body. Thus, the board can be used as a step for entering and exiting through the opening which the door is associated with. In particular, the drive is operated in such a way that when the door is opened, i.e. the opening is released, the board is adjusted in such a way that it can be used by a person. For this purpose, particularly the board is extended so that it protrudes over other components of the body. However, when the door is closed, the board is expediently moved to a retracted position. It is particularly preferred that the door is driven by means of a further electric motor, and when the further electric motor is operated, particularly the drive of the electromotive footboard is likewise operated.

The advantages and further developments mentioned in connection with the electromotive footboard are to be transferred correspondingly to the motor vehicle and to each other and vice versa.

In the following, examples of embodiments of the invention are explained in more detail with reference to a drawing. In the figures:

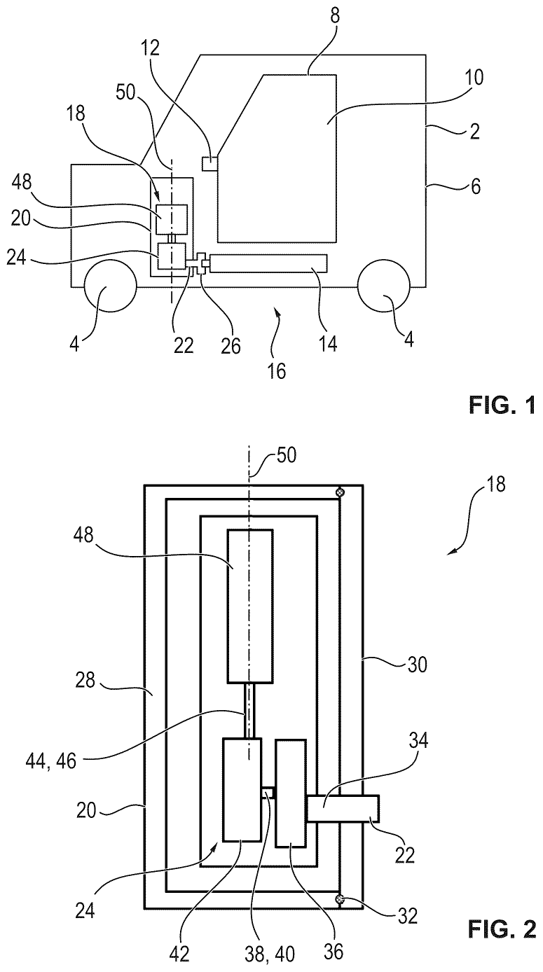

FIG. 1 is a schematic representation of a motor vehicle comprising a door, with which an electromotive footboard is associated,

FIG. 2 is a schematic representation in a sectional view of a drive of the electromotive footboard,

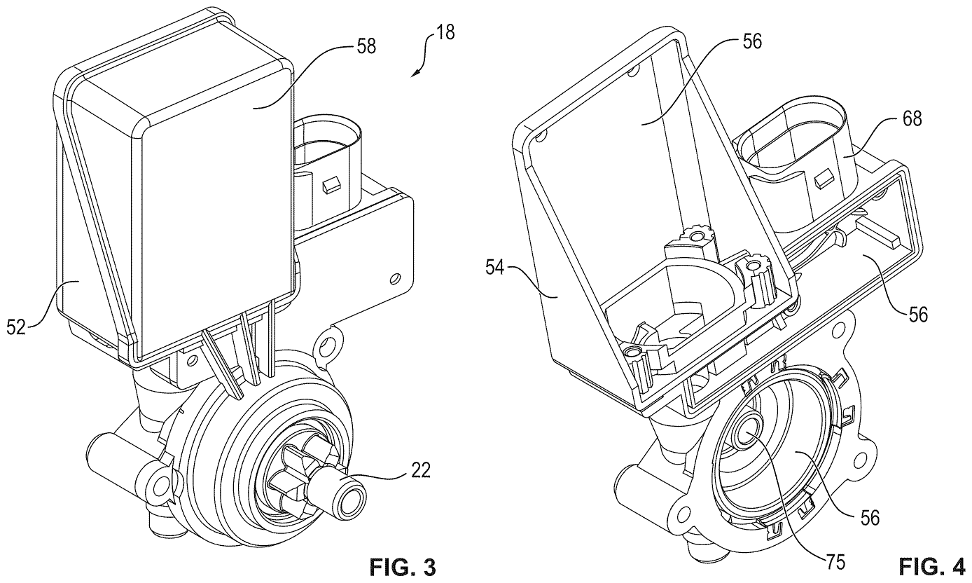

FIG. 3 is a perspective view of the drive,

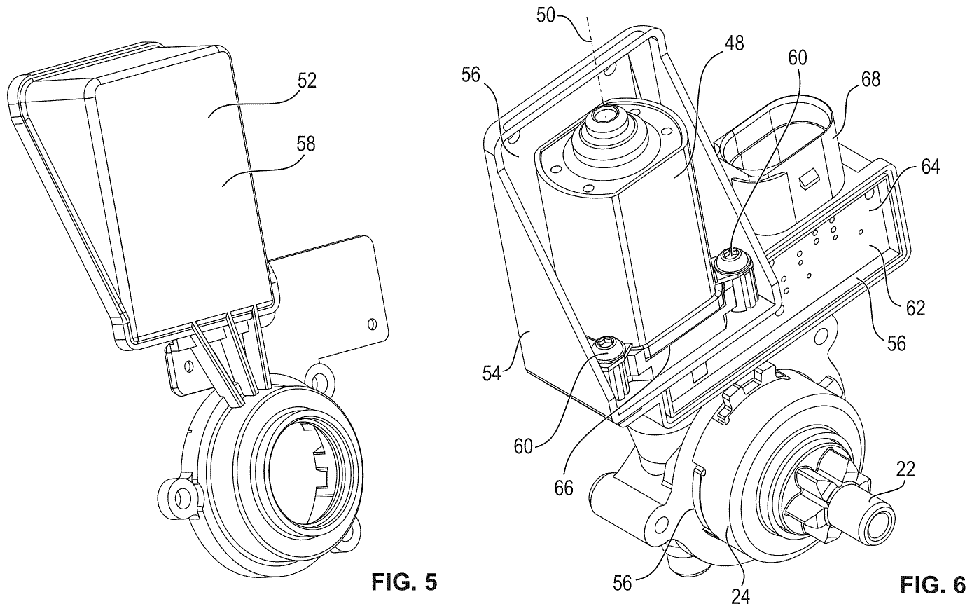

FIGS. 4, 5 each are perspective views of parts of a housing of the drive,

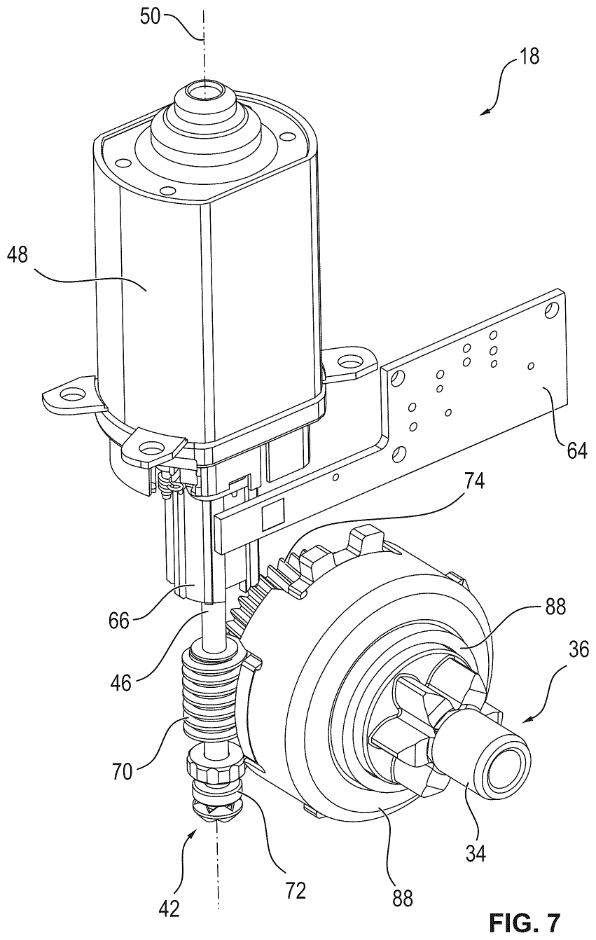

FIGS. 6, 7 each are perspective views of the drive, with parts of the housing omitted, and

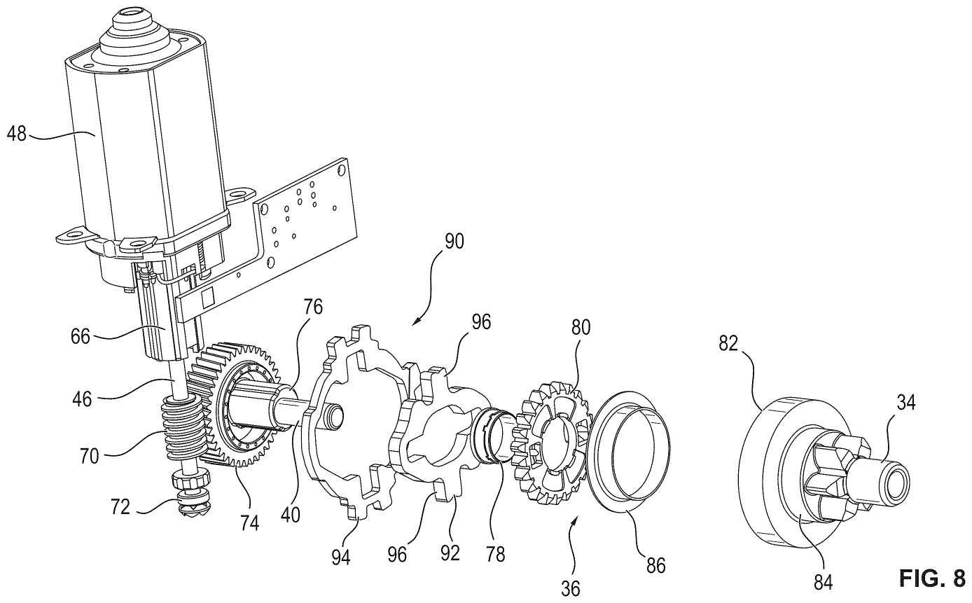

FIG. 8 is a perspective exploded view of a section of the drive, and

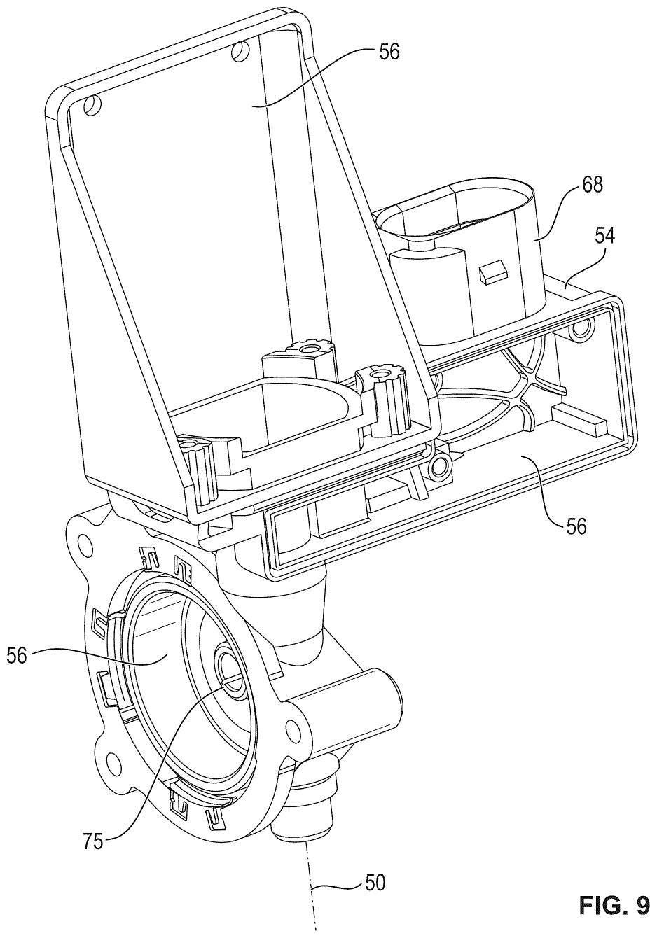

FIG. 9 is a perspective view of a section of an embodiment of the housing.

Corresponding parts are provided with the same reference numbers in all figures.

FIG. 1 shows a simplified schematic representation of a motor vehicle 2 in the form of a passenger car. The motor vehicle 2 has several wheels 4 which stand on the ground and which are connected, by means of a chassis not shown in detail, to a body 6. The motor vehicle 2 is designed as a pick-up and has comparatively large wheels 4 and a correspondingly designed chassis. As a result, a lower edge of the body 6 is comparatively far away from the ground.

The body 6 has an opening 8 which can be covered by a door 10. For this purpose, the door 10 is movably mounted on the body 6 by means of a hinge 12. In the vertical direction below the door, a board 14 of an electromotive footboard 16 is adjustably mounted, by means of a mechanism not shown in detail, to the body 6. The board 14 is arranged essentially horizontally and is driven by the mechanical system by means of the drive 18. Here, it is possible to move the board 14 relative to the body 6 by operating the drive 18, namely to extend and retract it. When retracted, the board 14 is flush with the outside of the body 6. When extended, the board 14 projects beyond the body 6 below the opening 8. Thus, a person can use the board 14 as a step to enter or exit through the opening 8. In summary, the electromotive footboard 14 is associated with the door 10.

The drive 18 is surrounded by a housing 20 through which an output shaft 22 of a gear unit 24 of the drive 18 is guided. At the end of the output shaft 22 located outside the housing 20, a coupling 26 is arranged on it. The output shaft 22 of the gear unit 24 is designed there to form the coupling 26. In other words, the coupling 26 is at least partially integral with the output shaft 22 of the gear unit 24. The coupling 24 is designed as a mechanical overload, namely as a tolerance ring coupling. The coupling 26 engages a counterpart of the mechanical system by means of which the board 14 is movably mounted.

FIG. 2 shows a simplified schematic sectional view of the drive 18 and the housing 20. This has a shell 28 which is box-shaped and is closed by means of a cover 30 of the enclosure 20. For this purpose, the cover 20 is placed on the edge of the shell 28 and rests there at least partially via a seal 32. The cover 30 is fastened to the shell 28 by means of several screws not shown in detail. The seal 32 and the screws are arranged in such a way that the enclosure 20 is sealed. In the example shown, the drive shaft 22 of the gear unit 24 protrudes through the cover 30. In a variant not shown in detail, a component is inserted into the cover 30 or the shell 28, which is rotatably mounted and driven by means of the drive shaft 22. The drive shaft 22 is then arranged completely inside the enclosure 20. In summary, however, the drive 18 is surrounded by the sealed enclosure 20.

The drive shaft 22 of the gear unit 24 is formed by an output shaft 34 of a second gear stage 36. The second gear stage 36 further comprises a drive shaft 38, which simultaneously forms an output shaft 40 of a first gear stage 42. Here, the output shaft 34 of the second gear stage 36 and the drive shaft 38 of the second gear stage 36 are arranged parallel to each other. The first gear stage 42 comprises a drive shaft 44 which forms a 90° angle in relation to the output shaft 40 of the first gear stage 40. Consequently, the first gear stage 42 is a 90° deflection gear. The drive shaft 44 of the first gear stage 42 is formed by a shaft 46 of an electric motor 48 of the drive 18, which is rotatably mounted about a rotational axis 50 of the electric motor 48.

In summary, the drive 18 has the electric motor 48, by means of which the gear unit 24 is driven, which has the first gear stage 42 and the second gear stage 36. The first gear stage 42 is driven directly by means of the electric motor 48, and the second gear stage 36 is driven directly by means of the first gear stage 42, by means of which the output shaft 22 of the gear unit 24 is formed. A 90° angle is formed between the rotational axis 50 of the electric motor 48 and the output shaft 22 of the gear unit 24 and thus of the drive 18.

FIG. 3 shows a perspective view of the drive 18. The drive 18 has a common housing 52 which comprises a housing body 54 shown in FIG. 4. The housing body 54 is produced by means of plastic injection molding and has several holders 56 which, in the assembled state, are covered by a common cover 58 which is shown in a perspective view in FIG. 5. The cover 58 is also made by plastic injection molding. The cover 58 of the housing 52 is fastened to the housing body 54 by means of screws (not shown in detail), and a seal is arranged between these, so that the housing 52 is sealed.

As shown in a perspective view in FIG. 6, the electric motor 48, which is designed as a brushed commutator motor, is arranged in one of the holders 56 of the housing body 54. The electric motor 48 is fastened there by means of several screws 60. In another of the holders 56, the gear unit 24 is inserted, which comprises the drive shaft 22 of the gear unit 24, which encloses the 90° angle in relation to the rotational axis 50 of the electric motor 48. Between these two holders 56, a further holder 46 is arranged, which is of elongated design. Inside this, an electronic unit 62 of the drive 18 is arranged, by means of which the electric motor 48 is energized. The electronic unit 62 has a substantially flat circuit board 64 to which electrical and/or electronic components not shown in detail are fastened and interconnected. The circuit board 64 is electrically connected to the electric motor 48, namely to a brush system 66 which has carbon brushes not shown in detail. This holder 56 is associated with a connector housing 68, which is formed by means of the housing body 54 and in which connectors that are not shown in detail are arranged, which are electrically connected directly to the circuit board 64. Consequently, the electronic unit 62 is an integrated electronic unit arranged on the electric motor 48.

FIG. 7 shows a perspective view and FIG. 8 shows a perspective exploded view of the drive 18, wherein the housing 52 is omitted. The circuit board 64 has sockets that are not shown in detail, into which corresponding connections of the brush system 66 are guided, wherein the circuit board 64 also lies at least partially flat against the brush system 66 and is arranged parallel to the rotational axis 50.

On the shaft 46 of the electric motor 48, a worm 70 of the first gear stage 42 is non-rotatably fastened. On the side of the worm 70 facing away from the brush system 66, the shaft 46 is mounted by means of a further bearing 72 which is fastened to the housing body 54. A worm gear 74 of the first gear stage 42 is engaged with the worm 70, and the worm gear is mounted on the output shaft 40 of the first gear stage 42, the end of which rests in a bearing 75 located at the bottom of the cup-shaped holder 56 associated with the gear unit 24. The bearing 75 is formed by means of a pot-shaped section, by means of which the end of the output shaft 40 of the first gear stage 42 is surrounded, wherein a plain bearing is formed. In summary, the first gear stage 42 is designed as a worm gear set, and the first gear stage 42 thus comprises the worm gear set.

An eccentric cam 76 of the second gear stage 36 is molded for a perfect fit and thus fastened to one end face of the worm gear 74. The eccentric cam 76 is not concentric to the rotational axis of the worm gear 74 and is therefore moved eccentrically around the rotational axis of the worm gear 74 when the drive 18 is operated. A first bearing 78 is mounted on the eccentric 76 and is inserted into a central holder of a first gearwheel 80, so that the first gearwheel 80 is rotatably mounted on and with respect to the eccentric 76. The first gearwheel 80 is inserted into a second gearwheel 82 which is internally toothed and which has a larger inner radius than the outer radius of the first gearwheel 80 and an increased number of teeth. The second gearwheel 82 merges into the output shaft 34 of the second gear stage 36, which is loosely placed on the output shaft 40 of the first gear stage 42 and is rotatably mounted thereon. Thus, the number of components is reduced. The second gearwheel 82 has a collar 84 arranged concentrically to its rotational axis, onto which a second bearing 86 is placed, so that the collar 84 is surrounded by the second bearing 86. The second bearing 86, in turn, is inserted into a central holder in the bottom of a pot-shaped cover 88, which is not shown in FIG. 8. By means of the cover 88, in the assembled state, the holder 56 associated with the gear unit 24 is covered, and the individual components of the gear unit 34 are held in the holder 56 by means of the cover 88.

To guide the first gearwheel 80, a cross slide 90 is provided, which comprises a first motion link 92 and a second motion link 94, which are arranged perpendicular to the rotational axis of the second gearwheel 82. The first motion link 92 has a central holder within which the first bearing 78 is located. The first motion link 92 has two projecting extensions 96 which are inserted into corresponding holders of the second motion link 94, so that the first motion link 92 is mounted on the second motion link 94 in a longitudinally movable, namely slidingly movable manner. The second motion link 94, in turn, is mounted perpendicularly to the cover 88 in a longitudinally movable, i.e. slidingly movable manner. Thus, by means of the cross slide 90, a type of Oldham coupling is provided, and the offset of the rotational axis of the first gearwheel 80 in relation to the rotational axis of the worm gear 74, which is equal to the rotational axis of the second gearwheel 82, is compensated. In summary, the second gear stage 36 is designed as an eccentric gear and thus comprises the eccentric gear.

The reduction achieved by means of the drive 18 depends on the ratio of the teeth 80 of the first gearwheel 80 to the teeth of the second gearwheel 82 and on the number of teeth of the worm gear 74, at least if always the same worm 70 is used. The number of teeth of the worm gear 74 in turn depends on the diameter of the worm gear 74. Based on the position of the bearing 75, the position of the drive shaft 40 of the first gear stage 42 is predetermined, and thus also the position and diameter of the worm gear 74 are predetermined. Further, the position of the second gearwheel 82 and consequently also of the output shaft 34 of the second gear stage 36 are predetermined.

In order to allow the drive 18 to be adapted to different applications, namely different motor vehicle types/doors 10, wherein allowing a comparatively large number of identical parts to be used, the bearing 75 is adjustable. Consequently, the drive 18 has the adjustable bearing 75 of the worm gear 74 on the housing 52. To achieve this, in a variant not shown in detail, several corresponding bearings 75 are arranged on the bottom of the associated holder 56, one of which is used depending on the use of worm gear 74. In an alternative, an adjustable slide is introduced into the injection mold, which is used to create the housing body 54, the adjustment of which predetermines the position of the bearing 75.

In FIG. 9, an alternative embodiment of the housing body 54 is shown. The holders 56 associated with the electronic unit 62 and the electric motor 48 as well as their arrangement relative to each other have not been changed. For example, the connector housing 68 is present again. In the assembled state, the arrangement of the electronic unit 62 and the electric motor 48 is therefore not changed, and this corresponds to the previous variant.

However, compared to the previous embodiment, the holder 56, which is associated with the gear unit 24, is rotated by 90° about the rotational axis 50 of the electric motor 48. Thus, in the assembled state, the shaft 46 continues to protrude into this holder 56. The gear unit 34 is not changed, but it is also rotated by 90° in relation to the other components. Consequently, the circuit board 64 now runs parallel to the output shaft 34 of the second gear stage 36. In comparison to the previous embodiment, in which the drive 18 is comparatively flat, a lateral extension is now adapted to a corresponding installation situation of the motor vehicle 2.

The invention is not restricted to the embodiments described above. Rather, other variants of the invention can likewise be derived from this by the person skilled in the art without departing from the subject matter of the invention. In particular, all individual features described in connection with the individual embodiments can further also be combined with one another in other ways without departing from the subject matter of the invention.

### LIST OF REFERENCE NUMBERS

2 motor vehicles
4 wheel
6 body
8 opening
10 door
12 hinge
14 board
16 electromotive footboard
18 drive
20 enclosure
22 output shaft of the gear unit
24 gear unit
26 coupling
28 bowl
30 cover
32 seal
34 drive shaft of the second gear stage
36 second gear stage
38 drive shaft of the second gear stage
40 drive shaft of the first gear stage
42 first gear stage
44 drive shaft of the first gear stage
46 shaft
48 electric motor
50 rotational axis
52 housing
54 housing body
56 holder
58 cover
60 screw
62 electronics
64 circuit board
66 brush system
68 connector housing
70 worm
72 additional bearing
74 worm gear
75 bearing
76 eccentric cam
78 first bearing
80 first gearwheel
82 second gearwheel
84 collar
86 second bearing
88 cover
90 cross slide
92 first motion link
94 second motion link

1. An electromotive footboard for a motor vehicle, with a board which is driven by means of a drive which has an electric motor and a gear unit driven thereby and having an output shaft which comprises a first gear stage and a second gear stage, wherein the first gear stage has a worm gear set, and wherein a drive shaft and an output shaft of the second gear stage are parallel to each other.

2. The electromotive footboard according to claim 1,
wherein a 90° angle is formed between a rotational axis of the electric motor and the drive shaft of the transmission.

3. The electromotive footboard according to claim 1,
wherein the second gear stage comprises an eccentric gear.

4. The electromotive footboard according to claim 3,
wherein an eccentric cam of the eccentric gear is fastened to the worm gear.

5. The electromotive footboard according to claim 1,
wherein on the electric motor, an electronic system of the drive is arranged, with the electronic system being used to energize the electric motor.

6. The electromotive footboard according to claim 1,
wherein the drive has a common housing.

7. The electromotive footboard according to claim 6,
wherein an adjustable bearing of the worm gear on the housing.

8. The electromotive footboard according to claim 1,
wherein the drive is surrounded by a sealed enclosure.

9. The electromotive footboard according to claim 1,
wherein at the end of the output shaft (22) of the gear unit (24), a coupling (26) is arranged.

10. The electromotive footboard according to claim 9,
wherein the coupling is designed as a mechanical overload coupling.

11. A motor vehicle with a door with which an electromotive footboard according to claim 1 is associated.

12. The electromotive footboard according to claim 2, wherein the second gear stage comprises an eccentric gear.
